(19) United States
(12) Patent Application Publication
(10) Pub. No.: US 2025/0306359 A1
(43) Pub. Date: Oct. 2, 2025

(54) VARIABLE WAVELENGTH INTERFERENCE FILTER

(71) Applicant: SEIKO EPSON CORPORATION, TOKYO (JP)

(72) Inventors: Kikuya MORITA, SHIOJIRI-SHI (JP); Kunihiko YANO, SHIOJIRI-SHI (JP)

(21) Appl. No.: 19/090,467

(22) Filed: Mar. 26, 2025

(30) Foreign Application Priority Data
Mar. 26, 2024 (JP) 2024-050213

(51) Int. Cl. G02B 26/00

(52) U.S. Cl. CPC G02B 26/001

(57) ABSTRACT

A variable wavelength interference filter according to the present embodiment includes a first reflective film and a second reflective film opposed to each other via a gap, and an actuator section that changes the gap to thereby change a peak wavelength of transmitted light transmitted through the first reflective film and the second reflective film. Each of the first reflective film and the second reflective film is a multilayer film formed of totally six or more layers by alternately stacking high-refractive index layers and low-refractive index layers lower in refractive index than the high-refractive index layers. Optical film thicknesses of the layers constituting the first reflective film and optical film thicknesses of the layers constituting the second reflective film have respective arrangements symmetric about the gap. In a setting wavelength band in which the peak wavelength appears, and which has a width no smaller than 700 nm, a variation range of a reflection phase in each of the multilayer films of the first reflective film and the second reflective film is within 120 degrees.

The present application is based on, and claims priority from JP Application Serial Number 2024-050213, filed Mar. 26, 2024, the disclosure of which is hereby incorporated by reference herein in its entirety.

### BACKGROUND

### 1. Technical Field

The present disclosure relates to a variable wavelength interference filter.

### 2. Related Art

In the past, a variable wavelength interference filter that transmits light with a predetermined wavelength out of incident light has been known as a type of a spectral filter (see, e.g., JP-A-2021-15146). The variable wavelength interference filter includes a pair of substrates, a pair of reflective films provided to the pair of substrates and opposed to each other across a gap, and an electrostatic actuator for changing the gap. When one of the pair of substrates is displaced toward the other by the electrostatic actuator, the gap dimension between the pair of reflective films changes, and light with a specific wavelength corresponding to the gap dimension is transmitted through the variable wavelength interference filter.

In the variable wavelength interference filter described above, a multilayer film in which high-refractive index layers and low-refractive index layers are alternately stacked is used as a general reflective film, and an optical film thickness of each layer constituting the multilayer film is designed to be λ_{d}/4 based on an intended design wavelength λ_{d}. For example, FIG. 12 is a graph showing the film thicknesses of the respective layers constituting the reflective films F1, F2 side by side. In FIG. 12, “AIR” represents a gap between the reflective films F1, F2, “H” represents a high-refractive index layer, and “L” represents a low-refractive index layer.

In the variable wavelength interference filter having the reflective films F1, F2, since a peak of the transmittance (hereinafter referred to as a transmittance peak) appears at the design wavelength λ_{d}, by changing the gap, a predetermined wavelength band centered on the design wavelength λ_{d} can be used as a dispersible band. However, since another transmittance peak occurs at a wavelength separated by about 100 nm from the design wavelength λ_{d}, the dispersible band becomes about 200 nm wide, which makes it difficult to widen the band.

Therefore, in the variable wavelength interference filter described in JP-A-2021-15146, a multilayer film designed based on a plurality of design wavelengths λ_{d} is used as the reflective film for the purpose of widening the dispersible band. For example, FIG. 13 is a graph in which the film thicknesses of the respective layers constituting the reflective films F3, F4 are arranged side by side with respect to the reflective films F3, F4 designed based on the plurality of design wavelengths λ_{d1}, λ_{d2}. In FIG. 13, the reflective films F3, F4 have a multilayer film structure S1 in which the film thickness of each layer is designed to be λ_{d1}/4, and a multilayer film structure S2 in which the film thickness of each layer is designed to be λ_{d2}/4. In the variable wavelength interference filter having the reflective films F3, F4, the dispersible band is relatively widened and becomes about 600 nm.

JP-A-2021-15146 is an example of the related art.

However, in the variable wavelength interference filter designed based on the plurality of design wavelengths λ_{d1}, λ_{d2} as illustrated in FIG. 13, not only a plurality of transmittance peaks corresponding to the design wavelengths λ_{d1}, λ_{d2} appear, but unintended transmittance peaks may appear at wavelengths close to the design wavelengths λ_{d1}, λ_{d2} in some cases. Therefore, in order to use the variable wavelength interference filter as the spectral filter, it is necessary to combine a filter capable of blocking light at the unintended transmittance peak. Therefore, the overall size of the spectral filter increases or an amount of light transmitted through the spectral filter decreases.

### SUMMARY

A variable wavelength interference filter according to an aspect of the present disclosure includes a first reflective film and a second reflective film opposed to each other via a gap, and an actuator section configured to change the gap to thereby change a peak wavelength of transmitted light transmitted through the first reflective film and the second reflective film, wherein each of the first reflective film and the second reflective film is a multilayer film formed of totally six or more layers by alternately stacking high-refractive index layers and low-refractive index layers lower in refractive index than the high-refractive index layers, optical film thicknesses of the layers constituting the first reflective film and optical film thicknesses of the layers constituting the second reflective film have respective arrangements symmetrical about the gap, and a variation range of a reflection phase in the multilayer film is within 120 degrees in a setting wavelength band in which the peak wavelength appears, and which has a width no smaller than 700 nm.

### BRIEF DESCRIPTION OF THE DRAWINGS

FIG. 1 is a cross-sectional view showing a schematic configuration of a variable wavelength interference filter according to an embodiment of the present disclosure.

FIG. 2 is a graph illustrating an arrangement of optical film thicknesses of respective layers constituting a reflective film in the variable wavelength interference filter according to the present embodiment.

FIG. 3 is a graph showing reflectance and reflection phase in the reflective film in Practical Example 1.

FIG. 4 is a graph illustrating a transmittance peak obtained every time a gap is changed in Practical Example 1.

FIG. 5 is a graph showing half-value widths of transmittance peaks in Practical Example 1, Comparative Example 1, and Comparative Example 2.

FIG. 6 is a graph showing reflectance and reflection phase in the reflective film in Practical Example 2.

FIG. 7 is a graph illustrating a transmittance peak obtained every time a gap is changed in Practical Example 2.

FIG. 8 is a graph showing half-value widths of transmittance peaks in Practical Example 2, Comparative Example 3, and Comparative Example 4.

FIG. 9 is a graph showing reflectance and reflection phase in the reflective film in Practical Example 3.

FIG. 10 is a graph illustrating a transmittance peak obtained every time a gap is changed in Practical Example 3.

FIG. 11 is a graph showing a half-value width of a transmittance peak in Practical Example 3.

FIG. 12 is a graph illustrating an arrangement of optical film thicknesses of respective layers constituting a reflective film in a related-art variable wavelength interference filter.

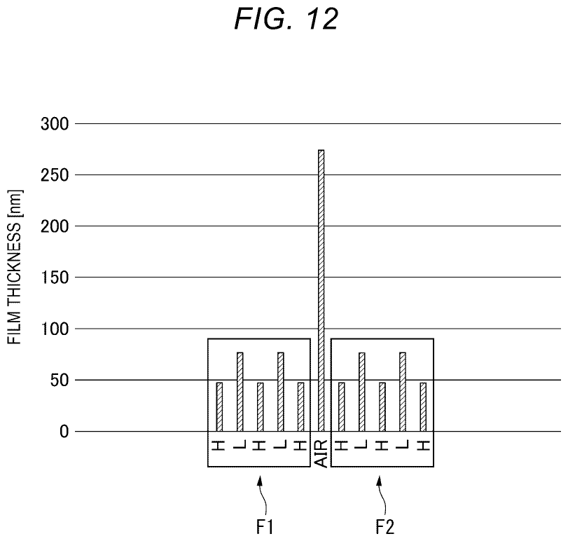

FIG. 13 is a graph illustrating an arrangement of optical film thicknesses of respective layers constituting a reflective film in another related-art variable wavelength interference filter.

FIG. 14 is a graph showing reflectance and reflection phase in a reflective film in Comparative Example 5.

FIG. 15 is a graph showing transmittance of transmitted light in Comparative Example 5.

### DESCRIPTION OF EMBODIMENTS

A variable wavelength interference filter 1 according to the present embodiment will hereinafter be described with reference to the drawings.

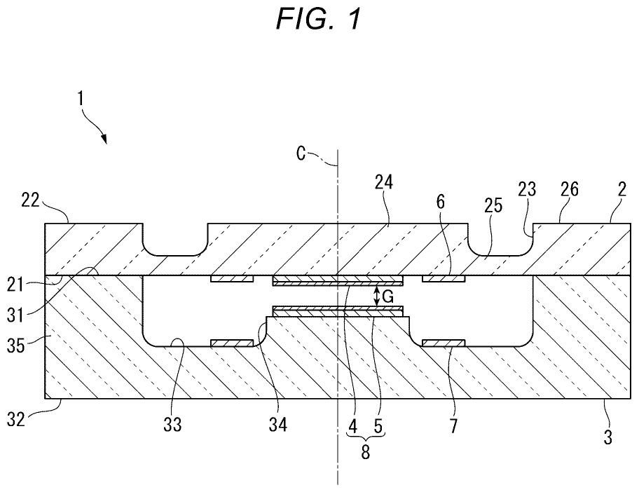

As shown in FIG. 1, the variable wavelength interference filter 1 according to the present embodiment includes a first substrate 2 and a second substrate 3 which are arranged to be opposed to each other, a first reflective film 4 and a first electrode 6 which are provided to the first substrate 2, and a second reflective film 5 and a second electrode 7 which are provided to the second substrate 3.

Note that the variable wavelength interference filter 1 is a spectral filter that changes the wavelength of light to be transmitted through the variable wavelength interference filter 1 by changing a gap G between the first reflective film 4 and the second reflective film 5 opposed to each other, and can be used as, for example, a spectrometric apparatus for performing spectrometry on light from a measurement object.

### Configuration of Variable Wavelength Interference Filter 1

A configuration of the variable wavelength interference filter 1 will be described with reference to FIG. 1. In the following description, a direction from the first substrate 2 toward the second substrate 3 is referred to as an optical axis direction. The optical axis direction is a direction along a central axis C of the variable wavelength interference filter 1, and corresponds to a thickness direction of the variable wavelength interference filter 1.

The first substrate 2 and the second substrate 3 are each formed of a material having light transmissive property in any wavelength band such as a silicon substrate or a glass substrate. Further, the first substrate 2 and the second substrate 3 are integrally configured as a structure that forms a cavity therebetween.

Specifically, the first substrate 2 includes a first surface 21 opposed to the second substrate 3 and a second surface 22 as a surface opposite to the first surface 21. When viewing the first substrate 2 from the optical axis direction, an annular groove 23 surrounding the first reflective film 4 is provided to the second surface 22 of the first substrate 2. Thus, the first substrate 2 includes a movable portion 24 which is a region provided with the first reflective film 4, a diaphragm portion 25 which is a region thin in thickness and disposed so as to surround the movable portion 24, and a base portion 26 which displaceably supports the movable portion 24 via the diaphragm portion 25.

The second substrate 3 has a third surface 31 opposed to the first substrate 2 and a fourth surface 32 as a surface opposite to the third surface 31. A recess 33 having a predetermined depth is provided to the third surface 31 of the second substrate 3, and the recess 33 forms the cavity between the first substrate 2 and the second substrate 3.

Further, the second substrate 3 includes a pedestal portion 34 disposed in a central region in the recess 33 and a base portion 35 which is a region disposed around the recess 33. The second reflective film 5 is disposed on an upper surface of the pedestal portion 34, and the second electrode 7 is disposed on a bottom surface of the recess 33. The height in the Z direction of the pedestal portion 34 is set in accordance with an initial value of the gap G between the first reflective film 4 and the second reflective film 5.

The base portion 26 of the first substrate 2 and the base portion 35 of the second substrate 3 are bonded to each other via a bonding portion (not shown).

The first reflective film 4 is disposed on the first surface 21 in the movable portion 24 of the first substrate 2. Further, in a plan view viewed from the optical axis direction, the first reflective film 4 has a substantially circular shape centered on the central axis C of the variable wavelength interference filter 1.

The second reflective film 5 is disposed on the upper surface of the pedestal portion 34 of the second substrate 3, and the first reflective film 4 and the second reflective film 5 are disposed so as to be opposed to each other via the predetermined gap G in the optical axis direction. Further, in a plan view viewed from the optical axis direction, the second reflective film 5 has a substantially circular shape centered on the central axis C of the variable wavelength interference filter 1.

In the present embodiment, when viewing the variable wavelength interference filter 1 from the optical axis direction, a region where the first reflective film 4 and the second reflective film 5 overlap each other forms a filter region which transmits light with a predetermined wavelength. The transmission wavelength of the filter region corresponds to the dimension of the gap G between the first reflective film 4 and the second reflective film 5. Note that although details will be described later, a dielectric multilayer film can be used as the first reflective film 4 and the second reflective film 5.

The first electrode 6 is disposed on the first surface 21 of the first substrate 2. Further, in the plan view viewed from the optical axis direction, the first electrode 6 has a substantially annular shape centered on the central axis C of the variable wavelength interference filter 1, and is disposed around the first reflective film 4.

The first electrode 6 is formed of an alloy film such as a metal laminate of Au/Cr. Further, the first electrode 6 is coupled to a control circuit via an electrode line or the like (not shown), and is set to a ground potential.

The second electrode 7 is disposed on the bottom surface of the recess 33 of the second substrate 3. Further, in the plan view viewed from the optical axis direction, the second electrode 7 has a substantially annular shape centered on the central axis C of the variable wavelength interference filter 1, and is disposed around the first reflective film 4.

Similarly to the first electrode 6, the second electrode 7 is formed of an alloy film such as a metal laminate of Au/Cr. Further, the second electrode 7 is coupled to the control circuit via an electrode line or the like (not shown), and constitutes an actuator section 8 together with the first electrode 6. Here, a drive voltage for driving the actuator section 8 is applied to the second electrode 7 by the control circuit. The actuator section 8 generates electrostatic attractive force between the first electrode 6 and the second electrode 7 to displace the movable portion 24 of the first substrate 2 in the Z direction toward the second substrate 3 to thereby change the gap G.

Note that as the control circuit for controlling the variable wavelength interference filter 1 according to the present embodiment, substantially the same configuration as in the related art can be used.

Configurations of First Reflective Film 4 and Second Reflective Film 5

Configurations of the first reflective film 4 and the second reflective film 5 will hereinafter be described. Hereinafter, the first reflective film 4 and the second reflective film 5 may simply be referred to as reflective films 4, 5.

The reflective films 4, 5 are multilayer films obtained by alternately stacking high-refractive index layers and low-refractive index layers lower in refractive index than the high-refractive index layers. For example, the low-refractive index layer is made of SiO₂ (silicon oxide), and the high-refractive index layer is made of Si (silicon).

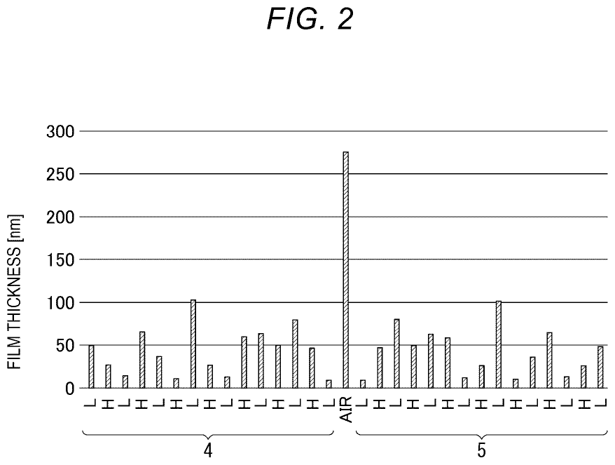

FIG. 2 is a graph illustrating the optical film thicknesses of the respective layers constituting the reflective films 4, 5. In FIG. 2, “AIR” represents the gap G between the reflective films 4, 5, “H” represents the high-refractive index layer, and “L” represents the low-refractive index layer. Note that the optical film thickness of each of the high-refractive index layer and the low-refractive index layer is a value obtained by the product of the refractive index of a layer material and the film thickness of the layer.

As shown in FIG. 2, the optical film thicknesses of the respective layers constituting the reflective films 4, 5 have respective arrangements symmetric about the gap G (AIR in the drawing). That is, the reflective films 4, 5 have the same configuration as each other except that the arrangements of the optical film thicknesses of the respective layers are symmetrical.

Here, the optical film thicknesses of the respective layers constituting the reflective films 4, 5 are designed based on a concept different from that of the design in the related art. That is, the optical film thicknesses of the respective layers constituting the reflective films 4, 5 are not designed so as to be λ_{d}/4 with respect to the design wavelength λ_{d}, and are designed based on design conditions described later.

The reflective film 4 will hereinafter be described as an example, but substantially the same description is also applied to the reflective film 5.

First, as the design condition, a wavelength band including a desired dispersible band is set as a setting wavelength band WB. For example, in the present embodiment, the setting wavelength band WB with a width no smaller than 700 nm is set so that the dispersible band equivalent to or greater than the dispersible band in JP-A-2021-15146 described above can be realized. Note that it is preferable to set the setting wavelength band WB with a margin of about 50 nm above and below the desired dispersible band.

Further, the reflectance of the reflective film 4 in the setting wavelength band WB is set as the design condition. Specifically, it is sufficient to set the reflectance of the reflective film 4 in the setting wavelength band WB so high that the transmittance peak of the variable wavelength interference filter 1 appears in the setting wavelength band WB. For example, the reflectance of the reflective film 4 in the setting wavelength band WB is set no lower than at least 60%, preferably no lower than 90%. Further, it is preferable for the reflectance to be set so that the longer the wavelength in the setting wavelength band WB is, the higher the reflectance is.

Further, the reflection phase of the reflective film 4 in the setting wavelength band WB is set as the design condition. Here, the reflection phase of the reflective film 4 is a phase shift which occurs when the light is reflected by the reflective film 4. Under the design condition of the reflection phase, a variation range of the reflection phase in the setting wavelength band WB (i.e., a range from the minimum value to the maximum value of the reflection phase in the setting wavelength band WB) is limited to be within 120 degrees, preferably within 80 degrees. Note that the reflection phase is not particularly limited as long as the variation range in the setting wavelength band WB is within 120 degrees.

Further, as the design condition, the total number of layers constituting the reflective film 4 (hereinafter referred to as the total number of layers) is set to no smaller than six. The upper limit of the total number of layers of the reflective film 4 is not particularly limited, but is preferably no larger than 15 taking prevention of complication of a deposition process, a specification of simulation software described later, and so on into consideration.

In order to realize the reflective film 4 satisfying the design conditions described above, it is sufficient to input data representing the design conditions into the simulation software to calculate the optical film thicknesses of the respective layers of the reflective film 4. That is, by inputting data representing the design conditions described above to the simulation software, it is possible to calculate the optical film thicknesses of the respective layers of the reflective film 4 fitted to these design conditions. The simulation software is not particularly limited, but general and commercially-available thin film simulation software (e.g., application name: “Optilayer,” manufacturer: “OptiLayer GmbH”) can be used.

The reflective films 4, 5 satisfying the above design conditions have such a film thickness structure as illustrated in FIG. 2. That is, the layers constituting the reflective films 4, 5 have the optical film thicknesses different from those in the related-art design concept. According to the variable wavelength interference filter 1 including such reflective films 4, 5, the peak of the transmitted light in the setting wavelength band WB can be obtained as a single peak.

Some simulation results of the variable wavelength interference filter 1 according to the present embodiment will hereinafter be described as practical examples. Note that the same simulation software as described above can be used.

### Practical Example 1

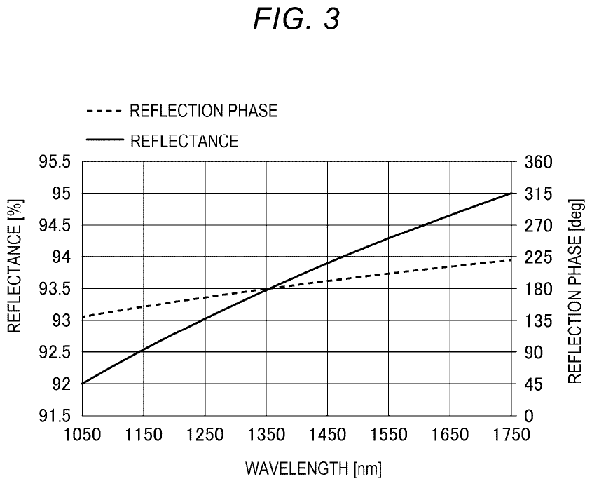

In the variable wavelength interference filter 1 according to the present embodiment, an example in which the reflective films 4, 5 are designed in accordance with the design conditions shown in FIG. 3 is referred to as Practical Example 1. Note that FIG. 3 is a graph showing the reflectance and reflection phase of the reflective films 4, 5 in the setting wavelength band WB. Specifically, the reflectance of the reflective films 4, 5 is 90% or more in the setting wavelength band WB, and the longer the wavelength is, the higher the reflectance becomes. The variation range of the reflection phase of the reflective films 4, 5 in the setting wavelength band WB is limited within 80 degrees, that is, from 120 degrees to 220 degrees. Further, the setting wavelength band WB in Practical Example 1 is 700 nm in width from 1050 nm to 1750 nm, and the total number of layers in each of the reflective films 4, 5 is 12.

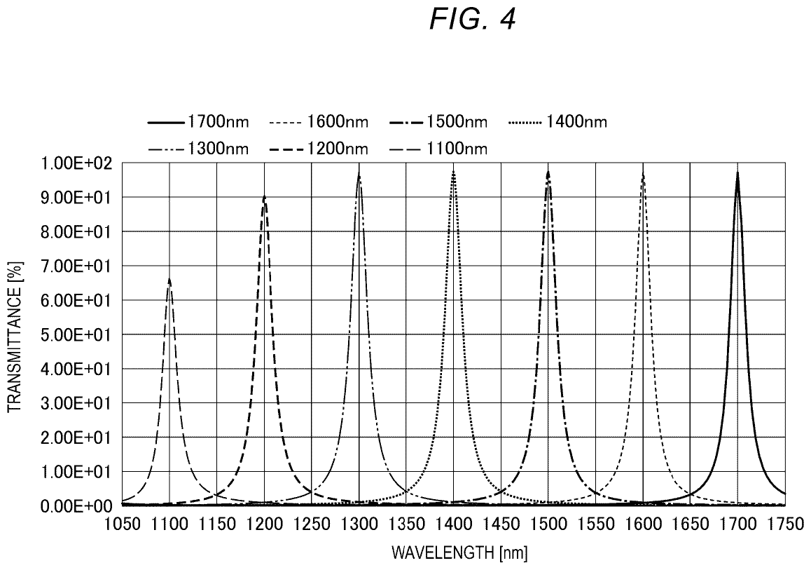

FIG. 4 is a graph showing the spectral characteristics of the variable wavelength interference filter 1 according to Practical Example 1. In FIG. 4, the dimension of the gap G was adjusted so that the transmission wavelength was changed every 100 nm within the setting wavelength band WB, and the transmittance of the variable wavelength interference filter 1 in each adjustment was obtained. Note that in FIG. 4, the transmission wavelengths are set to 1100 nm, 1200 nm, 1300 nm, 1400 nm, 1500 nm, 1600 nm, and 1700 nm.

As shown in FIG. 4, in Practical Example 1, even when taking any of the wavelengths as the transmission wavelength, the transmittance peak in the setting wavelength band WB became a single peak. Further, it was confirmed that a range of 600 nm, that is, from 1100 nm to 1700 nm, was available as the dispersible band.

### Comparison Between Practical Example 1 and Comparative Examples 1, 2

Comparative Example 1 is the same in basic configuration as the variable wavelength interference filter 1 according to the present embodiment, but has a pair of reflective films designed in substantially the same method as in the related art instead of the reflective films 4, 5. In Comparative Example 1, the design wavelength λ_{d} is set to 1400 nm which is the center of the setting wavelength band WB in Practical Example 1, and the optical film thicknesses of the respective layers constituting the reflective film are designed to be λ_{d}/4.

Comparative Example 2 has substantially the same configuration as that in Practical Example 1 except the total number of layers of each of the reflective films 4, 5. In Comparative Example 2, the total number of layers of each of the reflective films 4, 5 is set to five.

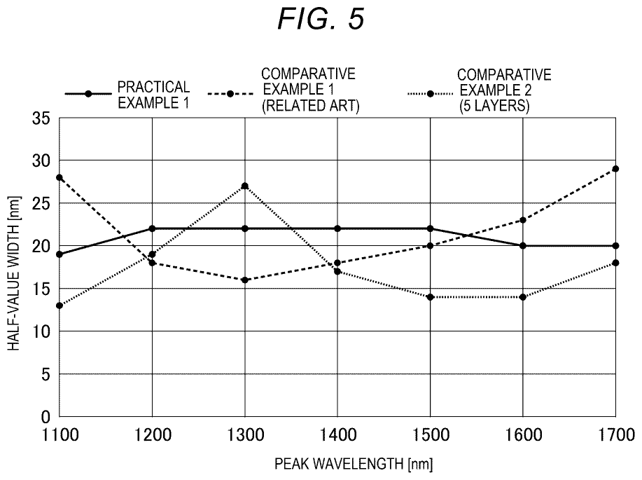

FIG. 5 is a graph showing a half-value width of the transmittance peak in each of Practical Example 1 and Comparative Examples 1, 2. In FIG. 5, the dimension of the gap G was adjusted so that the transmission wavelength was changed every 100 nm in the setting wavelength band WB, and the half-value width of the transmittance peak obtained at the transmission wavelength in each adjustment was obtained. Note that in FIG. 5, similarly to FIG. 4, the transmission wavelengths are set to 1100 nm, 1200 nm, 1300 nm, 1400 nm, 1500 nm, 1600 nm, and 1700 nm.

As shown in FIG. 5, in Practical Example 1, the half-value width of the transmittance peak changed in the vicinity of 20 nm in the setting wavelength band WB, and the variation in the half-value width was ±3 nm.

In contrast, in Comparative Example 1, as the distance from 1400 nm, which was the design wavelength λ_{d}, increased, the influence of the decrease in the reflectance of the reflective film appeared, and the half-value width of the transmittance peak increased. Accordingly, the variation in the half-value width in the setting wavelength band WB was ±6.5 nm. Further, although not shown in the drawings, a peak other than the transmittance peak appeared at a wavelength at a distance of about 100 nm to 200 nm from the transmission wavelength.

In Comparative Example 2, although the transmittance peak was a single peak in the setting wavelength band WB, the half-value width of the transmittance peak was not stabilized with respect to the wavelength in the setting wavelength band WB, and the variation in half-value width became ±7 nm.

### Practical Example 2

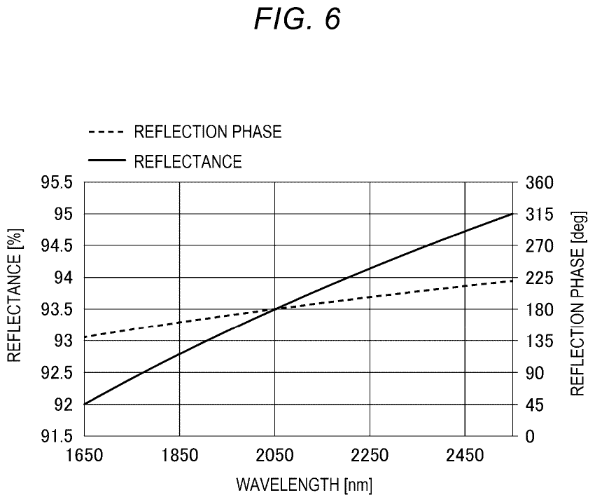

In the variable wavelength interference filter 1 according to the present embodiment, an example in which the reflective films 4, 5 are designed in accordance with the design conditions shown in FIG. 6 is referred to as Practical Example 2. Note that FIG. 6 is a graph showing the reflectance and reflection phase of the reflective films 4, 5 in the setting wavelength band WB. Specifically, the reflectance of the reflective films 4, 5 is 90% or more in the setting wavelength band WB, and the longer the wavelength is, the higher the reflectance becomes. The variation range of the reflection phase of the reflective films 4, 5 in the setting wavelength band WB is limited within 80 degrees, that is, from 120 degrees to 220 degrees. Further, the setting wavelength band WB in Practical Example 2 is 900 nm in width from 1650 nm to 2550 nm, and the total number of layers in each of the reflective films 4, 5 is 11.

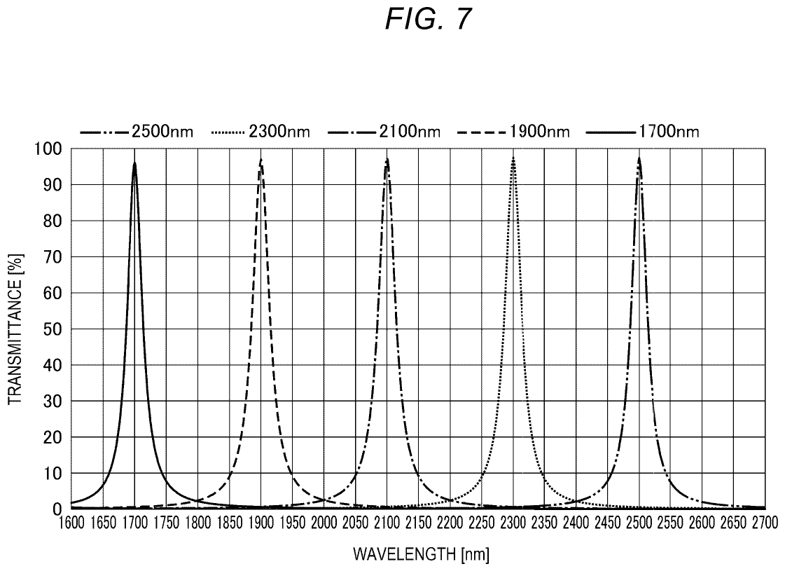

FIG. 7 is a diagram showing the spectral characteristics of the variable wavelength interference filter 1 according to Practical Example 2. In FIG. 7, the dimension of the gap G was adjusted so that the transmission wavelength was changed every 200 nm within the setting wavelength band WB, and the transmittance of the variable wavelength interference filter 1 in each adjustment was obtained. Note that in FIG. 7, the transmission wavelengths are set to 1700 nm, 1900 nm, 2100 nm, 2200 nm, and 2500 nm.

As shown in FIG. 7, in Practical Example 2, even when taking any of the wavelengths as the transmission wavelength, the transmittance peak in the setting wavelength band WB became a single peak. Further, it was confirmed that a range of 600 nm, that is, from 1100 nm to 1700 nm, was available as the dispersible band.

### Comparison Between Practical Example 2 and Comparative Examples 3, 4

Comparative Example 3 is the same in basic configuration as the variable wavelength interference filter 1 according to the present embodiment, but has a pair of reflective films designed in substantially the same method as in the related art instead of the reflective films 4, 5. In Comparative Example 3, the design wavelength λ_{d} is set to 2100 nm which is the center of the setting wavelength band WB in Practical Example 2, and the optical film thicknesses of the respective layers constituting the reflective film are designed to be λ_{d}/4.

Comparative Example 4 has substantially the same configuration as that in Practical Example 2 except the total number of layers of each of the reflective films 4, 5. In Comparative Example 4, the total number of layers of each of the reflective films 4, 5 is set to five.

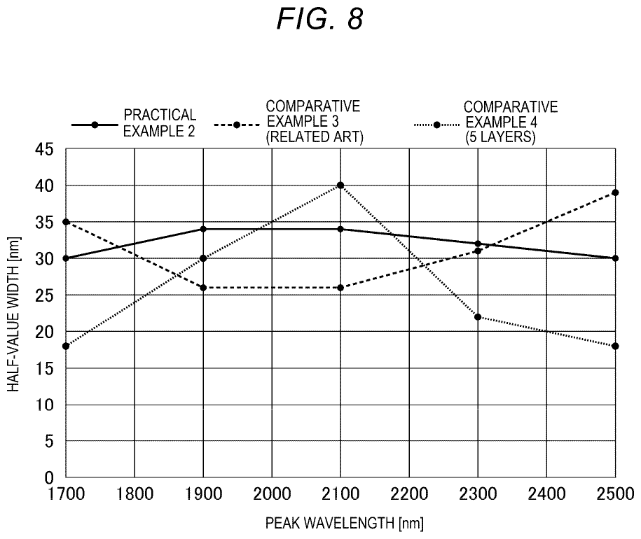

FIG. 8 is a graph showing a half-value width of the transmittance peak in each of Practical Example 2 and Comparative Examples 3, 4. In FIG. 8, the dimension of the gap G was adjusted so that the transmission wavelength was changed every 200 nm in the setting wavelength band WB, and the half-value width of the transmittance peak obtained at the transmission wavelength in each adjustment was obtained. Note that in FIG. 8, similarly to FIG. 7, the transmission wavelengths are set to 1700 nm, 1900 nm, 2100 nm, 2200 nm, and 2500 nm.

As shown in FIG. 8, in Practical Example 2, the half-value width of the transmittance peak changed in the vicinity of 32 nm in the setting wavelength band WB, and the variation in the half-value width in the measurement range was ±2 nm.

In contrast, in Comparative Example 3, as the distance from 2100 nm, which was the design wavelength λ_{d}, increased, the influence of the decrease in the reflectance of the reflective film appeared, and the half-value width of the transmittance peak increased. Accordingly, the variation in the half-value width in the setting wavelength band WB was ±4.5 nm. Further, although not shown in the drawings, a peak other than the transmittance peak appeared at a wavelength at a distance of about 100 nm to 200 nm from the transmission wavelength.

In Comparative Example 4, although the transmittance peak was a single peak in the setting wavelength band WB, the half-value width of the transmittance peak was not stabilized with respect to the wavelength in the setting wavelength band WB, and the variation in half-value width became ±11 nm.

### Practical Example 3

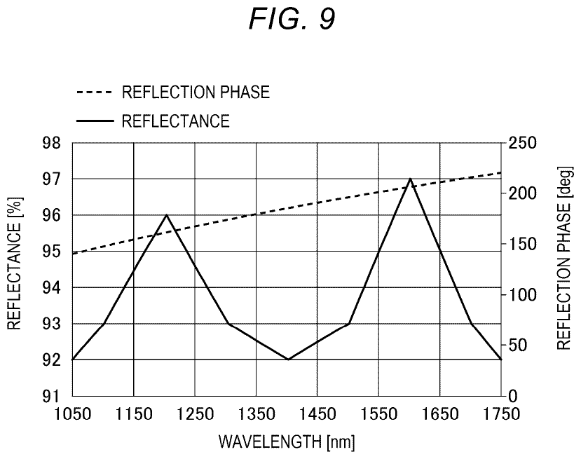

An example in which a reflectance different from that of Practical Example 1 is set in the variable wavelength interference filter 1 according to the present embodiment is referred to as Practical Example 3. Specifically, in Practical Example 3, the reflective films 4, 5 are designed in accordance with the design conditions shown in FIG. 9. FIG. 9 is a graph showing the reflectance and reflection phase of the reflective films 4, 5 in the setting wavelength band WB. Here, the reflectance of the reflective films 4, 5 is no lower than 90% in the setting wavelength band WB, and peaks at two specific wavelengths (i.e., 1200 nm and 1600 nm).

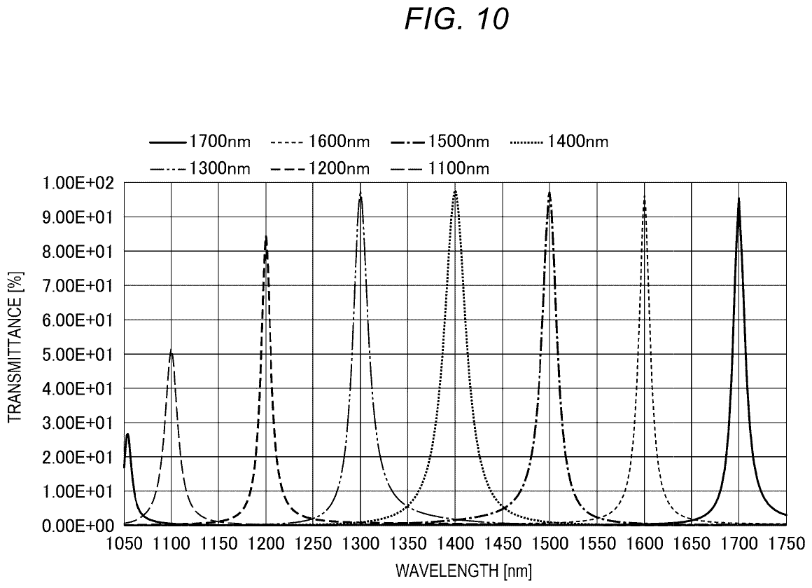

FIG. 10 is a graph showing the spectral characteristics of the variable wavelength interference filter 1 according to Practical Example 3. In FIG. 10, the dimension of the gap G was adjusted so that the transmission wavelength was changed every 100 nm within the setting wavelength band WB, and the transmittance of the variable wavelength interference filter 1 in each adjustment was obtained.

As shown in FIG. 10, in Practical Example 3, even when taking any of the wavelengths as the transmission wavelength, the transmittance peak in the setting wavelength band WB became a single peak.

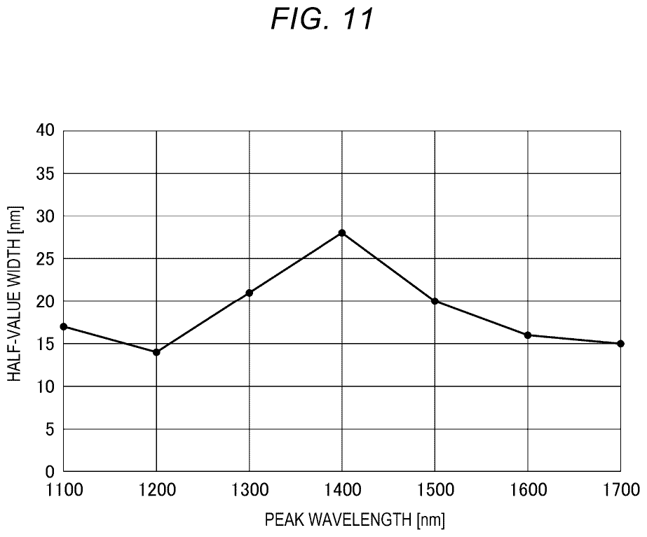

FIG. 11 is a graph showing the transition of the half-value width of the transmittance peak in FIG. 10. As shown in FIG. 11, in Practical Example 3, the half-value width of the transmittance peak decreased at two specific wavelengths (i.e., 1200 nm and 1600 nm) at which the reflectance peaks. That is, a sharper transmittance peak than others was successfully obtained at the two specific wavelengths.

### Comparative Example 5

Comparative Example 5 is the same in basic configuration as the variable wavelength interference filter 1 according to the present embodiment, but has a pair of reflective films F3, F4 designed in substantially the same method as in the related art instead of the reflective films 4, 5.

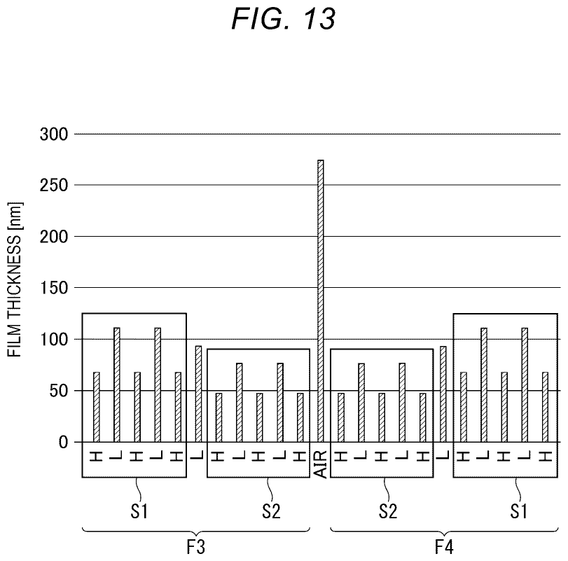

In Comparative Example 5, the dispersible band is widened by substantially the same method as in JP-A-2021-15146. That is, in Comparative Example 5, the reflective films F3, F4 designed based on the two design wavelengths λ_{d1}, λ_{d2} (specifically, 450 nm, 650 nm) are used. Accordingly, as illustrated in FIG. 13, the reflective films F3, F4 in Comparative Example 5 have the multilayer film structure S1 in which the film thickness of each layer is designed to be λ_{d1}/4, and the multilayer film structure S2 in which the film thickness of each layer is designed to be λ_{d2}/4.

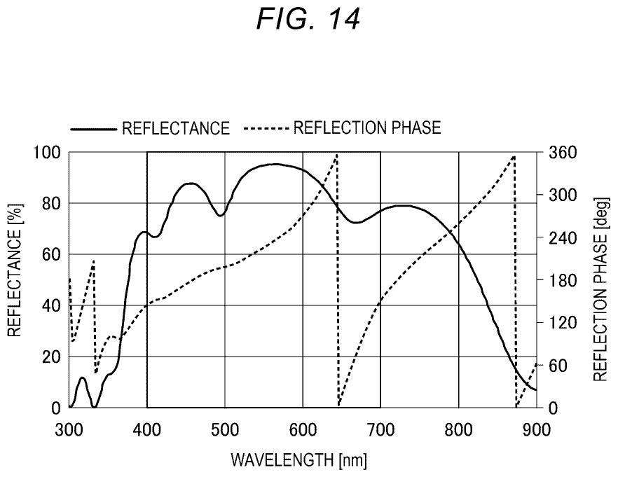

When obtaining the reflectance and the reflection phase of each of the reflective films F3, F4 of Comparative Example 5, a graph shown in FIG. 14 was obtained. In FIG. 14, the reflectance in Comparative Example 5 has a relatively high value (no lower than about 80%) in the vicinity of each of the wavelengths of 450 nm and 650 nm, which are the two design wavelengths λ_{d1}, λ_{d2}. Further, in FIG. 14, the reflection phase changes from 270 to 360 degrees in a range from 600 to 640 nm, and the reflection phase changes from 0 to 140 degrees in a range from 640 to 700 nm. That is, in FIG. 14, the reflection phase is changed by 230 degrees in a range of 100 nm from 600 nm to 700 nm, which shows that the change of the reflection phase is large.

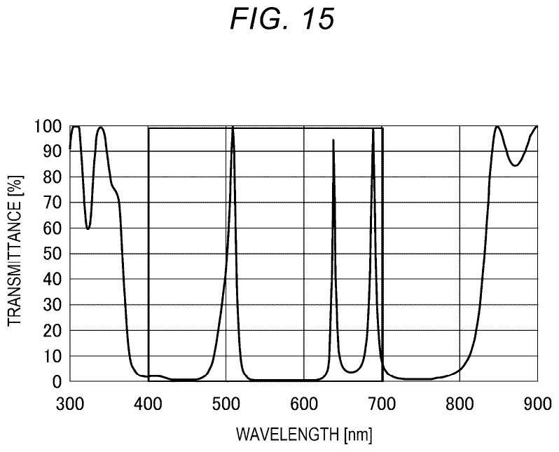

Here, FIG. 15 is a diagram showing the spectral characteristics of the variable wavelength interference filter 1 according to Practical Example 5, and shows the reflectance when controlling the gap G to a predetermined dimension. As shown in FIG. 15, in Comparative Example 5, not only the transmittance peaks appeared at the two wavelengths (around 500 nm and around 700 nm in the diagram) corresponding to the two design wavelengths λ_{d1}, λ_{d2}, but an extra transmittance peak appeared in a wavelength band (band of 600 to 700 nm) in which a large change in the reflection phase occurred.

### OTHER PRACTICAL EXAMPLES

The variation range of the reflection phase of the reflective films 4, 5 is limited within 80 degrees in the setting wavelength band WB with the width of 700 nm or the width of 900 nm in Practical Examples 1 to 3, but the simulation is performed while changing each of the setting wavelength band WB and the variation range of the reflection phase in each of Practical Examples 1 to 3. As a result, when the setting wavelength band WB was no smaller than 700 nm, by limiting the variation range of the reflection phase to 120 degrees at the maximum, the transmittance peak in the setting wavelength band WB was successfully obtained as the single peak. For example, in Practical Examples 1 to 3, when the limitation of the variation range of the reflection phase was changed from 80 degrees to 120 degrees, substantially the same results as the graphs shown in FIGS. 4, 7, and 10 were obtained.

### Functions and Advantages of Present Embodiment

(1) As described above, the variable wavelength interference filter 1 according to the present embodiment includes the first reflective film 4 and the second reflective film 5 opposed to each other via the gap G, and the actuator section 8 that changes the gap G to thereby change the peak wavelength of the transmitted light transmitted through the first reflective film 4 and the second reflective film 5. Each of the first reflective film 4 and the second reflective film 5 is a multilayer film formed of totally six or more layers by alternately stacking the high-refractive index layers and the low-refractive index layers lower in refractive index than the high-refractive index layers. The optical film thicknesses of the respective layers constituting the first reflective film 4 and the optical film thicknesses of the respective layers constituting the second reflective film 5 have respective arrangements symmetric about the gap G. In the setting wavelength band WB in which the peak wavelength appears, and which has a width no smaller than 700 nm, the variation range of the reflection phase in each of the multilayer films of the first reflective film 4 and the second reflective film 5 is within 120 degrees.

In the present embodiment, a significant change in the reflection phase is suppressed (i.e., the reflection phase is planarized) by limiting the variation range of the reflection phase in the reflective films 4, 5 in the setting wavelength band WB in which the transmittance peak appears. Thus, it is possible to prevent such extra transmittance peaks as generated in Comparative Example 5 described above from being generated. As a result, the transmittance peak can be obtained as a single peak in the setting wavelength band WB.

Here, the higher the degree of planarization of the reflection phase is made, the wider the wavelength band in which the single peak can be obtained becomes. Therefore, in the present embodiment, the degree of the planarization of the reflection phase in which the single peak can be obtained is realized by setting a range no smaller than 700 nm as the setting wavelength band WB so that the dispersible band in the same level as or broader than the related-art dispersible band can be realized, and limiting the variation range of the reflection phase within 120 degrees in this setting wavelength band WB. Such a degree of planarization of the reflection phase in the reflective films 4, 5 in the present embodiment (i.e., the variation range of the reflection phase is within 120 degrees in the width no smaller than 700 nm) is the optical characteristic which is not realized by the related-art design concept based on the design wavelength λ_{d}.

According to the variable wavelength interference filter 1 related to the present embodiment described above, the setting wavelength band WB can be used as the dispersible band. Further, in the variable wavelength interference filter 1 according to the present embodiment, it is possible to obtain the transmittance peak in the dispersible band as a single peak while widening the dispersible band.

Note that in the variable wavelength interference filter 1 according to the present embodiment, the total number of layers of each of the reflective films 4, 5 is limited to six or more. Accordingly, it is possible to provide the variable wavelength interference filter 1 suitable for the use as the spectral filter while suppressing the variation in the half-value width of the peak wavelength of the transmitted light.

Further, in the present embodiment, the upper limit width of the setting wavelength band WB and the lower limit width of the variation range of the reflection phase in the setting wavelength band WB are not particularly limited. That is, it is possible to obtain the advantage that the wider the setting wavelength band WB is, or the smaller the variation range of the reflection phase in the setting wavelength band is, the higher the degree of the planarization of the reflection phase in the setting wavelength band WB becomes, and thus the transmittance peak in the setting wavelength band becomes the single peak.

However, the higher the degree of planarization of the reflection phase in the setting wavelength band WB becomes, the larger the half-value width of the transmittance peak becomes. Therefore, when performing the spectroscopic measurement, it is preferable to determine the degree of planarization of the reflection phase in accordance with the half-value width of the transmittance peak required for the spectroscopic measurement.

(2) In the present embodiment, the total number of the high-refractive index layers and the low-refractive index layers is no larger than 15 in each of the reflective films 4, 5.

According to such a configuration, the deposition process of the reflective films 4, 5 can be performed in good conditions.

(3) In the present embodiment, it is preferable that the variation range of the reflection phase of each of the reflective films 4, 5 is within 80 degrees in the setting wavelength band WB.

According to such a configuration, the band in which the transmittance peak can be obtained as a single peak can be made wider.

(4) In the present embodiment, the longer the wavelength in the setting wavelength band WB is, the higher the reflectance of each of the reflective films 4, 5 may be.

When the reflectance of each of the reflective films 4, 5 in the setting wavelength band WB is supposedly constant, the longer the wavelength of the transmittance peak is, the half-value width of the transmittance peak becomes larger.

In contrast, according to such optical characteristics as in the present embodiment, when the wavelength of the transmittance peak is changed, the variation in the half-value width of the transmittance peak can be suppressed (see, e.g., Practical Examples 1, 2 described above).

(5) In the present embodiment, when the peak wavelength of the transmitted light is changed, the variation in the half-value width of the peak (transmittance peak) exhibited by the transmitted light is preferably within ±3 nm.

The variable wavelength interference filter 1 having such a configuration can suitably be used as a general spectral filter (see, e.g., Practical Examples 1, 2).

(6) In the present embodiment, the reflectance of each of the reflective films 4, 5 may exhibit a peak at a specific wavelength in the setting wavelength band WB.

In such a configuration, it is possible to realize the transmittance peak having a particularly narrow half-value width at a specific wavelength. The variable wavelength interference filter 1 having such a configuration can suitably be used as a special spectral filter (see, e.g., Practical Examples 3).

(7) In the present embodiment, the high-refractive index layer is preferably made of Si, and the low-refractive index layer is preferably made of SiO₂.

(8) In the present embodiment, the setting wavelength band WB may be 1050 nm to 1750 nm (see, e.g., Practical Examples 1 and 3).

(9) In the present embodiment, the setting wavelength band WB may be 1650 nm to 2550 nm (see, e.g., Practical Example 2).

### MODIFIED EXAMPLES

The present disclosure is not limited to the embodiment described above, and variations, improvements, and other modifications to the extent that the advantage of the present disclosure is achieved fall within the scope of the present disclosure.

In the embodiment described above, the setting wavelength band WB may be set to a wavelength band other than those illustrated in Practical Examples 1 to 3 described above. For example, the setting wavelength band WB is set mainly in the near-infrared region, but may be set in the visible band.

In the embodiment described above, Si and SiO₂ are exemplified as the materials of the layers constituting the reflective films 4, 5, but other materials may be used.

The variable wavelength interference filter 1 according to the embodiment described above may have another configuration as long as at least the reflective films 4, 5 satisfy the design conditions. For example, each of the reflective films 4, 5 may be provided with a detection electrode for detecting the dimension of the gap G.

What is claimed is:

1. A variable wavelength interference filter comprising:
a first reflective film and a second reflective film opposed to each other via a gap; and
an actuator section configured to change the gap to thereby change a peak wavelength of transmitted light transmitted through the first reflective film and the second reflective film, wherein
each of the first reflective film and the second reflective film is a multilayer film formed of totally six or more layers by alternately stacking high-refractive index layers and low-refractive index layers lower in refractive index than the high-refractive index layers,
optical film thicknesses of the layers constituting the first reflective film and optical film thicknesses of the layers constituting the second reflective film have respective arrangements symmetrical about the gap, and
a variation range of a reflection phase in the multilayer film is within 120 degrees in a setting wavelength band which includes the peak wavelength and has a width no smaller than 700 nm.

2. The variable wavelength interference filter according to claim 1, wherein
a total number of the high-refractive index layers and the low-refractive index layers is no larger than 15 in each of the first reflective film and the second reflective film.

3. The variable wavelength interference filter according to claim 1, wherein
the variation range of the reflection phase of each of the first reflective film and the second reflective film is within 80 degrees in the setting wavelength band.

4. The variable wavelength interference filter according to claim 1, wherein
the longer the wavelength in the setting wavelength band is, the higher reflectance of each of the first reflective film and the second reflective film is.

5. The variable wavelength interference filter according to claim 4, wherein
a variation in a half-value width of a peak exhibited by the transmitted light is within ±3 nm in the setting wavelength band.

6. The variable wavelength interference filter according to claim 1, wherein
reflectance of each of the first reflective film and the second reflective film exhibits a peak at a specific wavelength in the setting wavelength band.

7. The variable wavelength interference filter according to claim 1, wherein
the high-refractive index layer is made of Si, and
the low-refractive index layer is made of SiO₂.

8. The variable wavelength interference filter according to claim 1, wherein
the setting wavelength band is 1050 nm to 1750 nm.

9. The variable wavelength interference filter according to claim 1, wherein
the setting wavelength band is 1650 nm to 2550 nm.
